(19) United States
(12) Patent Application Publication
(10) Pub. No.: US 2018/0004418 A1
(43) Pub. Date: Jan. 4, 2018

(54) NON-UNIFIED CODE AND DATA DECODING TO PROVIDE EXECUTE-ONLY MEMORY

(71) Applicant: Intel Corporation, Santa Clara, CA (US)

(72) Inventors: Vedvyas Shanbhogue, Austin, TX (US); Ravi L. Sahita, Portland, OR (US)

(73) Assignee: Intel Corporation, Santa Clara, CA (US)

(21) Appl. No.: 15/201,066

(22) Filed: Jul. 1, 2016

(51) Int. Cl. G06F 3/06; G06F 12/14

(52) U.S. Cl. CPC G06F 3/0604; G06F 3/0673; G06F 12/1416; G06F 3/062; G06F 3/0659; G06F 3/0644; G06F 2212/1052

(57) ABSTRACT

In one embodiment, one or more regions of memory are designated as execute-only memory, wherein execute-only memory can only be accessed to retrieve code for execution, and wherein a designation of execute-only memory cannot be modified by system software executing on a processor. A data read request is detected within the execute-only memory, and the data read request is aborted. In addition, a code read request is detected within the execute-only memory, and the code read request is allowed. In some embodiments, a write request may also be detected within the execute-only memory, and the write request is aborted.

### TECHNICAL FIELD

This disclosure relates in general to the field of computer security, and more particularly, to providing execute-only memory.

### BACKGROUND

Computer systems utilize computer memory to store data and code associated with system software executing on the computer system. The contents of the computer memory can be read, written, or executed by the computer system.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of a computing device for providing an execute-only memory environment.

FIG. 2 illustrates memory read transactions in an example embodiment of an execute-only memory environment.

FIG. 3 illustrates aspects of memory in an example embodiment of an execute-only memory environment.

FIG. 4 illustrates aspects of an example embodiment of an execute-only memory environment.

FIG. 5 illustrates an example embodiment of a method for providing execute-only memory using non-unified code and data decoding.

FIG. 6 illustrates an example embodiment of a method for providing execute-only memory using non-unified code and data decoding with a cache.

### DETAILED DESCRIPTION OF EXAMPLE EMBODIMENTS

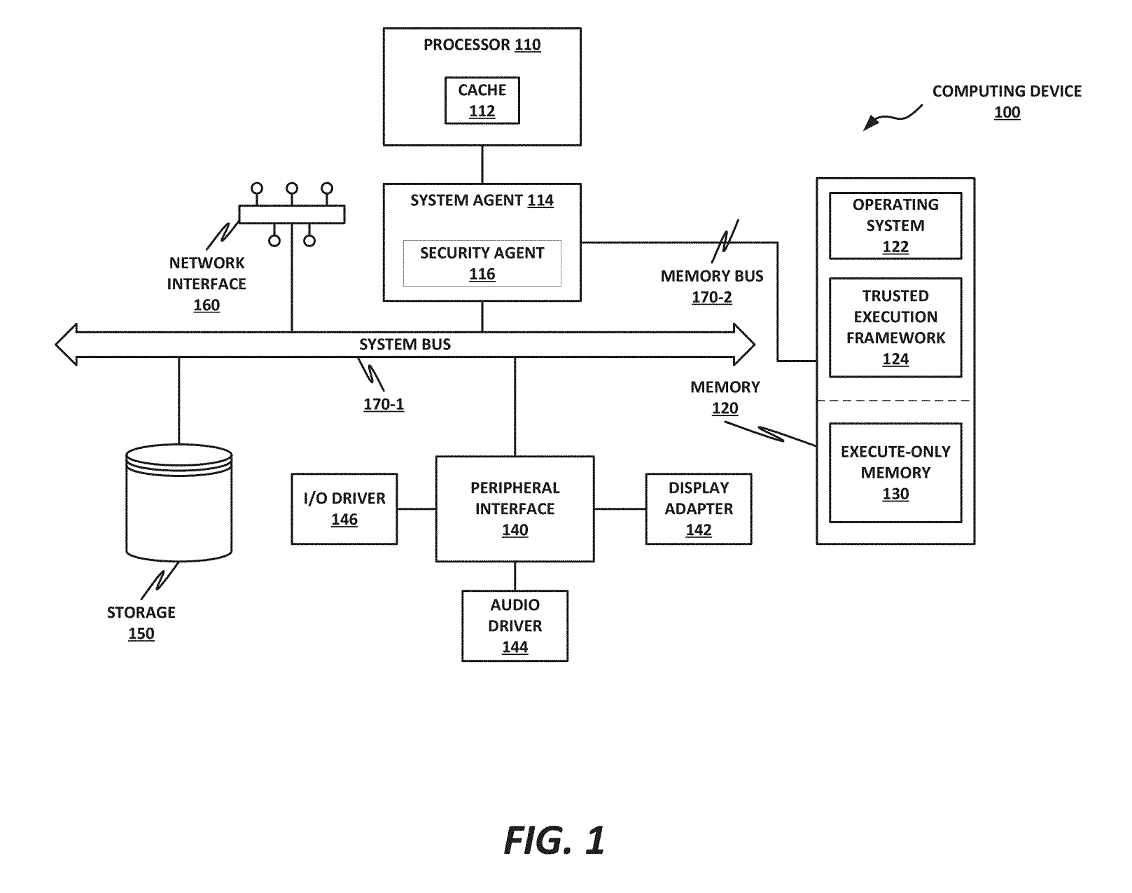

FIG. 1 illustrates an example embodiment of a computing device 100 for providing an execute-only memory environment, for example, using non-unified code and data decoding. Computing device 100 may be any suitable computing device. In various embodiments, a “computing device” may be or comprise, by way of non-limiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data.

Computing device 100 includes a processor 110 with a cache 112, which is connected to a system agent 114 for accessing memory 120 and other components of computing device 100. Computing device 100 may be managed by system software such as operating system 122. Operating system 122 may include any suitable operating system, such as Microsoft Windows, Linux, any UNIX-like or UNIX-based variant, Mac OS X, Apple iOS, Android, or other suitable operating system.

Memory 120 includes system software such as operating system 122, at least software portions of a trusted execution framework 124, and one or more regions of execute-only memory 130. System agent 114, which manages communications between processor 110 and other components of computing device 100, includes security agent 116 to securely configure and manage execute-only memory 130.

Other components of computing device 100 include a storage 150, network interface 160, and peripheral interface 140. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide memory 120 and storage 150, for example, in a single physical memory device, and in other cases, memory 120 and/or storage 150 are functionally distributed across many physical devices. In the case of virtual machines or hypervisors, all or part of a function may be provided in the form of software or firmware running over a virtualization layer to provide the disclosed logical function. In other examples, a device such as a network interface 160 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In one example, processor 110 may be communicatively coupled to memory 120 via system agent 114 and/or memory bus 170-2, which may be for example a direct memory access (DMA) bus by way of example, though other memory architectures are possible, including ones in which memory 120 communicates with processor 110 via system bus 170-1 or some other bus. Processor 110 may be communicatively coupled to other devices via system agent 114 and/or system bus 170-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 110 may be treated as only one core of a multi-core processor, or may be treated as the entire multi-core processor, as appropriate. In some embodiments, one or more co-processor may also be provided for specialized or support functions.

For simplicity, memory 120 is illustrated as a single logical block, but a physical embodiment may include one or more blocks of any suitable volatile or non-volatile memory technology or technologies, including for example DDR RAM, SRAM, DRAM, cache, L1 or L2 memory, on-chip memory, registers, flash, ROM, one-time programmable (OTP) memory, optical media, virtual memory regions, magnetic or tape memory, or similar. In certain embodiments, memory 120 may comprise a relatively low-latency volatile or non-volatile main memory, while storage 150 may comprise a relatively higher-latency non-volatile memory. However, memory 120 and storage 150 need not be physically separate devices, and in some examples may represent simply a logical separation of function. It should also be noted that although DMA is disclosed by way of non-limiting example, DMA is not the only protocol consistent with this specification, and that other memory architectures are available.

Processor 110 may also include, or may be coupled to, cache 112. Processor 110 may use cache 112 to provide low-latency access to information retrieved from memory 120. For example, cache 112 may provide faster memory access than provided by memory 120. Accordingly, processor 110 may use cache 112 to store information retrieved from memory 120 to allow faster access to that information. In some embodiments, cache 112 may be implemented as a hierarchy of caches, such as a level 1 cache (L1), level 2 cache (L2), level 3 cache (L3), mid-level cache (MLC), last level cache (LLC), and/or combinations thereof.

Storage 150 may be any species of memory 120, or may be a separate device. Storage 150 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 150 may be, or may include therein, a database or databases or data stored in other configurations, and may include a stored copy of system software such as operating system 122 and software portions of trusted execution framework 124. Many other configurations are also possible, and are intended to be encompassed within the broad scope of this specification.

Network interface 160 may be provided to communicatively couple computing device 100 to a wired or wireless network. A “network,” as used throughout this specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Peripheral interface 140 may be configured to interface with any auxiliary device that connects to computing device 100 but that is not necessarily a part of the core architecture of computing device 100. A peripheral may be operable to provide extended functionality to computing device 100, and may or may not be wholly dependent on computing device 100. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of non-limiting example.

In one example, peripherals include display adapter 142, audio driver 144, and input/output (I/O) driver 146. Display adapter 142 may be configured to provide a human-readable visual output, such as a command-line interface (CLI) or graphical desktop such as Microsoft Windows, Apple OSX desktop, or a Unix/Linux X Window System-based desktop. Display adapter 142 may provide output in any suitable format, such as a coaxial output, composite video, component video, VGA, or digital outputs such as DVI or HDMI, by way of non-limiting examples. In some examples, display adapter 142 may include a hardware graphics card, which may have its own memory and its own graphics processing unit (GPU). Audio driver 144 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of non-limiting examples.

Trusted execution framework (TEF) 124, in one example, is operable to provide a trusted environment to securely load and/or execute code and associated data. TEF 124 may include any suitable combination of hardware, software, and/or encoded logic for performing the functionality described herein for TEF 124. In one example, TEF 124 may include executable instructions and/or logic stored on a non-transitory computer-readable medium operable to instruct a processor or other electronic device to provide a trusted execution environment. In some cases, TEF 124 may additionally or alternatively include a special integrated circuit designed to fully or partially implement functionality of TEF 124.

TEF 124 may be used, for example, to attest to the authenticity of a platform or module, such as firmware, BIOS, and/or operating system 122. Attestation functionality of TEF 124 may be performed at any appropriate time, such as upon booting computing device 100 or upon a command from operating system 122. In some embodiments, TEF 124 may use microcode or an authenticated code module (ACM) to perform secure loading and attestation functionality.

In some cases, TEF 124 may run as a “daemon” process. A “daemon” may include any program or series of executable instructions, whether implemented in hardware, software, firmware, or any combination thereof that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space” associated with ring 0, 1, or 2 in a protection ring architecture. It should also be noted that TEF 124 may also include other hardware and software, including configuration files, registry entries, and interactive or user-mode software by way of non-limiting example.

System agent 114 may manage communication between processor 110 and other components of computing device 100. In various examples, system agent 114 may include any combination of logic elements configured to perform functionality of system agent 114 described herein, whether loaded from memory or other non-transitory computer readable medium, or implemented directly in hardware, including by way of non-limiting examples a microprocessor, digital signal processor, field-programmable gate array, graphics processing unit, programmable logic array, application-specific integrated circuit, or virtual machine processor. System agent 114 may be integrated with processor 110, or alternatively, system agent 114 may be implemented on a separate chip connected to processor 110. In some embodiments, system agent 114 may facilitate high-performance computing tasks. For example, system agent 114 may include a memory controller to provide an interface between processor 110 and memory 120. System agent 114 may also provide a bridge between processor 110 and other components of computing device 100, for example, using a direct media interface (DMI) and/or PCI-Express bridge. System agent 114 may also include security agent 116 to provide security functionality, including management of execute-only memory 130.

In some embodiments, security agent 116 may securely configure and manage execute-only memory 130, for example, to prevent code and embedded confidential information from being read from execute-only memory 130 for any purpose other than code execution. Security agent 116 may be any suitable combination of hardware, software, and/or encoded logic capable of performing the functionality described herein for security agent 116. In some embodiments, functionality of security agent 116 may be implemented by system agent 114, processor 110, a separate component connected to system agent 114 and/or processor 110, and/or a combination thereof.

In some embodiments, security agent 116 may designate one or more regions of memory 120 as execute-only memory 130. Execute-only memory 130 can only be accessed to retrieve code for execution. Execute-only memory 130 may be used, for example, to store protected information, such as firmware, any secrets or keys embedded in the firmware, and/or any other confidential code, logic, or associated information. Storing protected information, such as code and/or embedded confidential information, in execute-only memory 130 may prevent the protected information from being read or retrieved from memory for any purpose other than code execution. In this manner, confidential and/or proprietary intellectual property stored on execute-only memory 130 may be protected from access and/or reverse engineering by users of computing device 100.

In some embodiments, system software such as operating system 122 may separately be capable of designating one or more regions of memory 120 as execute-only memory. For example, operating system 122 may be capable of using page tables associated with a virtual memory system to designate certain regions of memory 120 as execute-only. Designations of execute-only memory by system software, however, can be controlled by the system software and/or users of the software. Accordingly, execute-only protection implemented by system software, such as operating system 122, cannot be used to protect confidential and/or proprietary intellectual property, because the system software or user of computing device 100 could remove the execute-only designation from the regions of memory 120 that are used to store the confidential and/or proprietary intellectual property. By contrast, the execute-only protection provided by security agent 116 exists independent of, and thus cannot be modified by, operating system 122 or other system software or components of computing device 100. Thus, system software such as operating system 122 cannot modify the designation of execute-only memory 130 by security agent 116.

In some embodiments, protected information (e.g., firmware) may be stored in a non-volatile memory component of memory 120, such as read-only memory (ROM), embedded flash memory, and/or one-time programmable (OTP) memory, which may be designated as execute-only memory 130 by security agent 116. In addition, or alternatively, protected information may be loaded into a volatile memory component of memory 120, such as one or more regions of random access memory (RAM), which may be designated as execute-only memory 130 by security agent 116. In some embodiments, the protected information may be securely loaded into memory 120 by a trusted entity, such as trusted execution framework (TEF) 124, an authenticated code module (ACM), and/or microcode. For example, security agent 116 may designate certain regions of RAM in memory 120 as execute-only memory 130, and TEF 124 may be used to securely load protected information, such as an encrypted firmware image, into the execute-only memory 130.

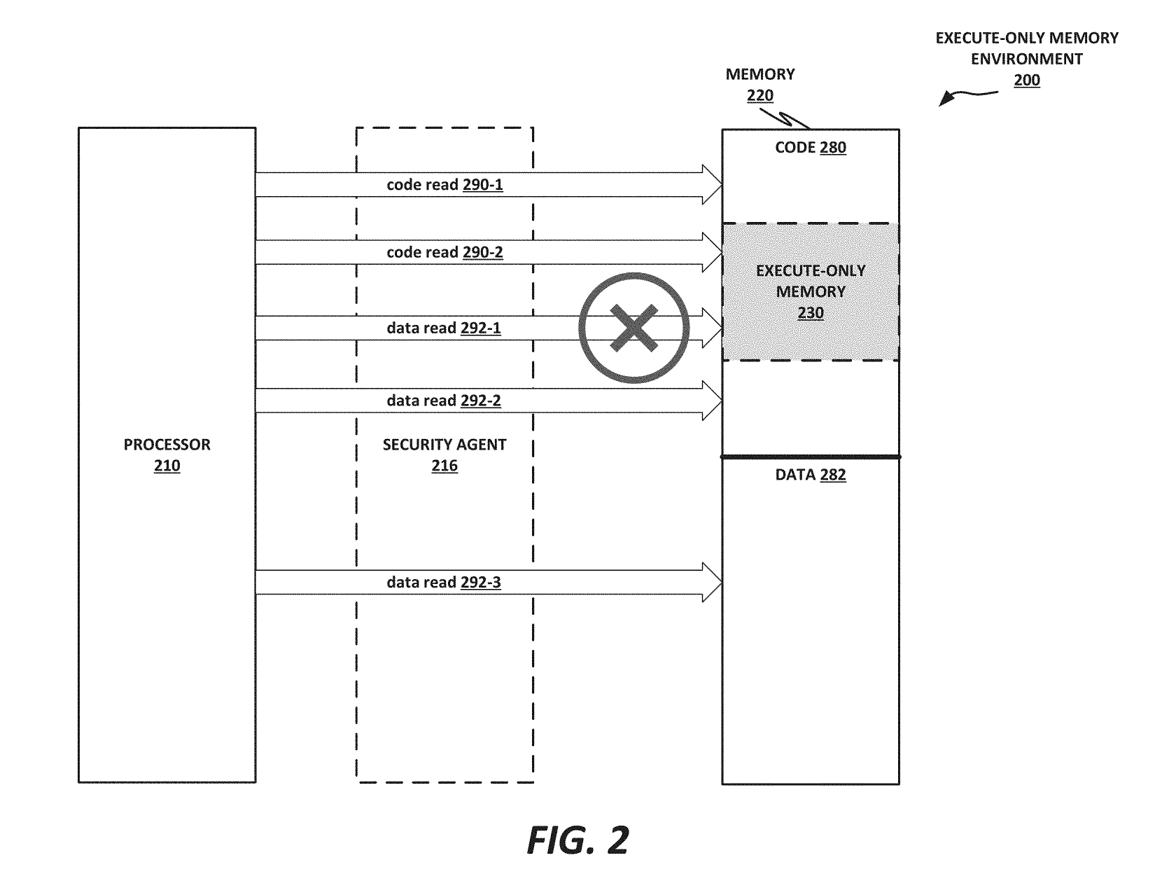

FIG. 2 illustrates memory read transactions 290 in an example embodiment of an execute-only memory environment 200. Execute-only memory environment 200 may be implemented by a computing device, for example, to provide execute-only memory 230 using non-unified code and data decoding. Execute-only memory environment 200 may be implemented by any suitable computing device, such as computing device 100 from FIG. 1. In the illustrated embodiment, execute-only memory environment 200 includes processor 210, security agent 216, and memory 220. In some embodiments, processor 210 may be similar to processor 110 of FIG. 1; security agent 216 may be similar to security agent 116 of FIG. 1; and memory 220 may be similar to memory 120 of FIG. 1.

In the illustrated embodiment, memory 220 is used store code 280 and data 282. Code 280 may include, for example, executable logic and/or instructions associated with a software component, such as firmware, an operating system, or an application. Data 282 may include, for example, any other type of information that is stored on memory 220 besides code 280, such as operating system data, application data, documents, user data, passwords, keys, etc.

Memory 220 includes a region of execute-only memory 230. In some embodiments, execute-only memory 230 may be similar to execute-only memory 130 from FIG. 1. Execute-only memory 230 may store code 280 associated with confidential and/or proprietary intellectual property, such as firmware. Code 280 stored in execute-only memory 230, and any embedded confidential information in that code 280 (e.g., keys), is protected from being read from execute-only memory 230 for any purpose other than code execution. In this manner, confidential and/or proprietary intellectual property stored as code 280 in execute-only memory 230 may be protected from access and/or reverse engineering by users of a computing device that makes use of the intellectual property. Similarly, any confidential information embedded in that code 280 (e.g., keys) is also protected from access by users of the computing device.

Processor 210 may be operable to execute software, such as firmware, an operating system, or an application. During execution, processor 210 may read and write information to and from memory 220. Processor 210 may read memory 220 for the purpose of either retrieving code 280 for execution or retrieving data 282 that is needed during execution of code 280. For example, processor 210 may execute software by reading the associated code 280 from memory 220 and executing instructions that are contained in that code 280. The instructions executed by processor 210 may in turn require data 282 to be read from or written to memory 220. For example, code 280 for an operating system may include instructions for authenticating a user. When the operating system needs to authenticate a user, processor 210 may access memory 220 to retrieve the code 280 that contains the instructions for authenticating a user. The instructions for authenticating the user may require the user's account information to be retrieved from memory 220, so processor 210 may then access memory 220 to retrieve data 282 corresponding to the user's account information.

Thus, processor 210 may read memory 220 for the purpose of either retrieving code 280 for execution or retrieving data 282 that is needed during execution of code 280. In some embodiments, processor 210 may use different types of memory read requests for reading code 280 versus data 282. For example, processor 210 may use code read requests 290 to read code 280 from memory 220 for execution, and data read requests 292 to read the contents of data 282 stored in memory 220. Software executing on processor 210, however, could instruct processor 210 to perform a data read request 292-2 at a memory address that actually contains code 280. This could allow a user to access software code 280 for reverse engineering. In some embodiments, however, code 280 stored in execute-only memory 230 cannot be read by a data read request 292-1. Rather, code 280 stored in execute-only memory 230 can only be read with a code read request 290-2 for purposes of executing the code 282. In this manner, code 280 stored in execute-only memory 230 can be executed, but it cannot otherwise be read or accessed by a user.

In some embodiments, security agent 216 may be used to manage designation and protection of execute-only memory 230. Security agent 216 may be independent from system software (e.g., an operating system) to prevent the system software from circumventing the protection of execute-only memory 230. In this manner, system software cannot modify the designation of execute-only memory 230 by security agent 216, nor can system software circumvent the protection of execute-only memory 230 that is provided by security agent 216. In some embodiments, security agent 216 may be implemented by a system agent, such as system agent 114 of FIG. 1.

Security agent 216 may protect execute-only memory 230 by managing requests from processor 210 to read memory 220, such as code read requests 290 and data read requests 292. In the illustrated embodiment, processor 210 submits code read request 290-1 to read code 280 for execution from memory 220. Security agent 216 allows code read request 290-1 and returns the requested code 280 to processor 210 for execution. Processor 210 also submits code read request 290-2 to read code 280 for execution from execute-only memory 230. Security agent 216 allows code read request 290-2 and returns the requested code 280 to processor 210 for execution. Processor 210 also submits data read request 292-1 to read code 280 from execute-only memory 230. Security agent 216 aborts data read request 292-1 since code 280 cannot be read from execute-only memory 230 using a data read request 292-1. In some embodiments, security agent 216 may respond to data read request 292-1 by returning a fixed pattern of data to indicate that the data read request has been aborted. Processor 210 also submits data read request 292-2 to read code 280 from memory 220. Security agent 216 allows data read request 292-2 since code 280 can be read from memory 220 using a data read request 292-1 as long as that code 280 is not stored in execute-only memory 230. Accordingly, security agent 216 returns the requested code 280 to processor 210. Finally, processor 210 submits data read request 292-3 to read data 282 from memory 220. Security agent 216 allows data read request 292-3 and returns the requested data 282 to processor 210.

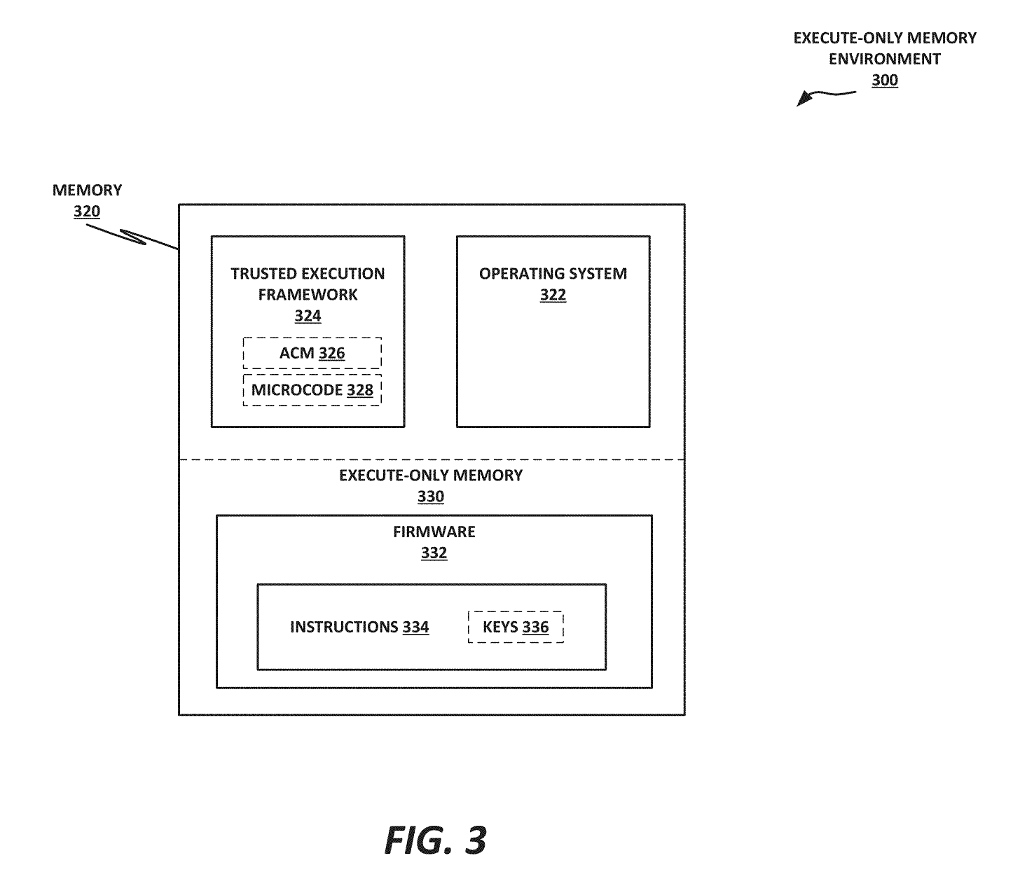

FIG. 3 illustrates aspects of memory 320 in an example embodiment of an execute-only memory environment 300. Execute-only memory environment 300 may be implemented by a computing device, for example, to provide execute-only memory 330 using non-unified code and data decoding. Execute-only memory environment 300 may be implemented by any suitable computing device, such as computing device 100 from FIG. 1. In the illustrated embodiment, execute-only memory environment 300 includes memory 320. In some embodiments, memory 320 may be similar to memory 120 of FIG. 1. In the illustrated embodiment, memory 320 includes trusted execution framework (TEF) 324, operating system 322, and execute-only memory 330. In some embodiments, TEF 324 may be similar to TEF 124 from FIG. 1; operating system 322 may be similar to operating system 122 from FIG. 1; and execute-only memory 330 may be similar to execute-only memory 130 from FIG. 1.

In the illustrated embodiment, execute-only memory 330 is used to store firmware 332. Firmware 332 may be, for example, software used to manage components of a computing device. Firmware 332 may include a collection of processor instructions 334. In some embodiments, instructions 334 of firmware 332 may further include embedded secrets or keys 336, such as device attestation keys, passwords, etc. For example, the keys 336 may be embedded as constant values in instructions 334 of firmware 332. In this manner, keys 336 are embedded in the code of firmware 332 rather than in data separate from the code of firmware 332.

In some cases, the developer of firmware 332 may seek to protect the contents of firmware 332, for example, by preventing firmware 332 from being accessed by a user seeking to reverse engineer and/or extract keys 336 from firmware 332. Accordingly, firmware 332 is stored in execute-only memory 330 to provide that protection. In some embodiments, execute-only memory 330 can only be read using code read requests for purposes of retrieving code for execution, while any data read requests for execute-only memory 330 are not allowed and will be aborted. For example, a security agent may be used to prevent execute-only memory 330 from being read for any purpose other than code execution, as described with respect to security agent 116 of FIG. 1 and security agent 216 of FIG. 2.

Trusted execution framework (TEF) 324 may be operable to provide a trusted environment to securely load and/or execute code. For example, in some embodiments, protected information such as firmware 332 may be securely loaded into execute-only memory 330 by a trusted entity, such as TEF 324. In the illustrated embodiment, TEF 324 includes authenticated code module (ACM) 326 and microcode 328. ACM 326 may be, for example, a digitally signed code module whose signature and integrity can be validated before being executed. In some embodiments, TEF 324 may use ACM 326 and/or microcode 328 to securely load protected information such as firmware 332 into execute-only memory 330. In some embodiments, TEF 324 may also use ACM 326 and/or microcode 328 to designate a region of memory 320 as execute-only memory 330 before loading protected information such as firmware 332.

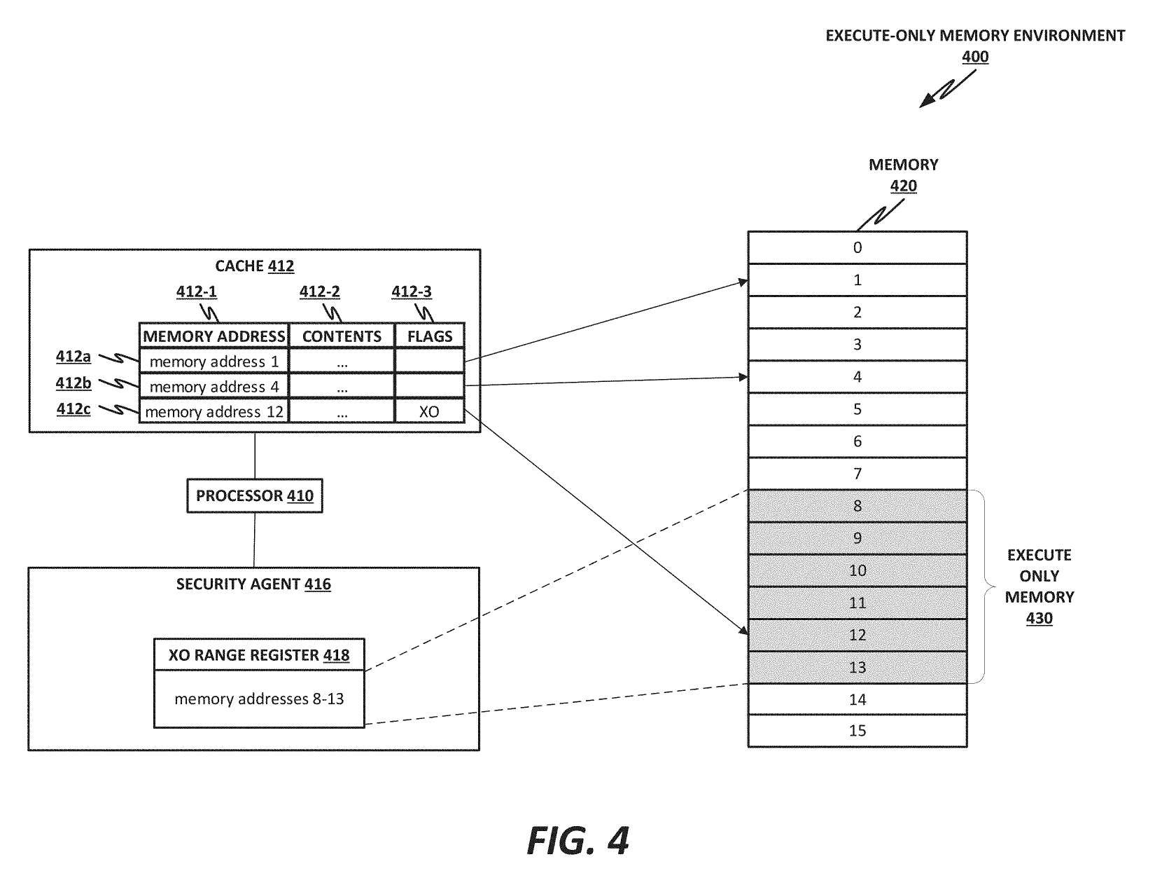

FIG. 4 illustrates aspects of an example embodiment of an execute-only memory environment 400. Execute-only memory environment 400 may be implemented by a computing device, for example, to provide execute-only memory 430 using non-unified code and data decoding. Execute-only memory environment 400 may be implemented by any suitable computing device, such as computing device 100 from FIG. 1. In the illustrated embodiment, execute-only memory environment 400 includes processor 410, cache 412, security agent 416, and memory 420. In some embodiments, processor 410 may be similar to processor 110 of FIG. 1; cache 412 may be similar to cache 112 of FIG. 1; security agent 416 may be similar to security agent 116 of FIG. 1; and memory 420 may be similar to memory 120 of FIG. 1.

Memory 420 includes a region of execute-only memory 430. In some embodiments, execute-only memory 430 may be similar to execute-only memory 130 from FIG. 1. Execute-only memory 430 may store code associated with confidential and/or proprietary intellectual property, such as firmware. Code stored in execute-only memory 430, and any embedded confidential information in that code (e.g., keys), is protected from being read from execute-only memory 430 for any purpose other than code execution. In this manner, confidential and/or proprietary intellectual property stored as code in execute-only memory 430 may be protected from access and/or reverse engineering by users of a computing device that makes use of the intellectual property. Similarly, any confidential information embedded in that code (e.g., keys) is also protected from access by users of the computing device. In the illustrated embodiment, memory 420 includes memory addresses 0-15, and execute-only memory 430 is designated as memory address 8-13 of memory 420.

Security agent 416 may be used to manage designation and protection of execute-only memory 430, for example, as described with respect to security agent 116 of FIG. 1 and security agent 216 of FIG. 2. Security agent 416 may first designate one or more regions of memory 420 as execute-only memory 430. Security agent 416 may only allow execute-only memory 430 to be read by processor 410 using code read requests for purposes of retrieving code for execution, while security agent 416 may abort any data read requests from processor 410 for execute-only memory 430. In some embodiments, security agent 416 may be independent from any system software being executed by processor 410 (e.g., an operating system) to prevent the system software from circumventing the protection of execute-only memory 430. In this manner, system software cannot modify the designation of execute-only memory 430 nor circumvent the protection of execute-only memory 430 that is provided by security agent 416.

In the illustrated embodiment, security agent 416 includes execute-only (XO) range register 418. XO range register 418 may be any suitable mechanism operable to identify regions of memory 420 that are designated as execute-only memory 430. In some embodiments, XO range register 418 may be a memory type range register (MTRR) or a persistent memory range register (PMRR). XO range register 418 may be used, for example, to identify the regions of memory 420 that are designated as execute-only memory 430. Thus, when security agent 416 receives a data read request from processor 410, security agent 416 may determine if the memory address identified by the data read request is within the regions of memory identified in XO range register 418. If the memory address identified by the data read request is within the regions of memory identified in XO range register 418, security agent 416 may abort the data read request. If the memory address identified by the data read request is not within the regions of memory identified in XO range register 418, security agent 416 may allow the data read request. In the illustrated embodiment, XO range register 418 identifies memory addresses 8-13 as the regions of memory 420 that are designated as execute-only memory 430. In this example, if the memory address identified by a data read request is within memory addresses 8-13, security agent 416 will abort the data read request. However, if the memory address identified by a data read request is not within memory addresses 8-13 (e.g., it is within memory addresses 0-7 or 14-15), security agent 416 will allow the data read request.

Processor 410 may include, or may be coupled to, cache 412. Processor 410 may use cache 412 to provide low-latency access to information retrieved from memory 420. For example, it may be faster for processor 410 to retrieve information stored on cache 412 than to retrieve information stored on memory 420. Thus, when processor 410 needs to read information from memory 420, processor 410 may first determine if that information is already stored in cache 412, and if so, processor 410 may retrieve the information from cache 412 rather than from memory 420. If the information is not stored in cache 412, processor 410 may retrieve the information from memory 420, and then may store the information on cache 412 for any subsequent reads of that same information.

In some embodiments, information stored in cache 412 may be flagged in cache 412 as execute-only (XO) if the corresponding memory address is within execute-only memory 430. For example, in some embodiments, when security agent 416 retrieves information from execute-only memory 430, security agent 416 may tag that information as execute-only (XO) when providing the information to processor 410. Processor 410 may then store that information in cache 412 with an execute-only (XO) flag. In this manner, when processor 410 satisfies memory read requests using cache 412 rather than memory 420, data read requests can be aborted if the corresponding cache entry 412a-412c is flagged as execute-only (XO).

In the illustrated embodiment, cache 412 includes entries 412a-412c and identifies the memory address 412-1, contents 412-2, and flags 412-3 associated with each entry. Cache entry 412a corresponds to memory address 1 of memory 420, cache entry 412b corresponds to memory address 4 of memory 420, and cache entry 412c corresponds to memory address 12 of memory 420. Processor 410 may use cache 412 rather than memory 420 to satisfy memory read requests for memory address 1, 4, or 12 since those memory addresses are stored in cache 412. Cache entry 412c is flagged as execute-only (XO), however, since memory address 12 is within execute-only memory 430. Thus, while a code read request for memory address 12 may be satisfied using cache 412, a data read request for memory address 12 will not be allowed. In some embodiments, a data read request for a cache entry flagged as execute-only (XO), such as cache entry 412c for memory address 12, may be treated as a cache miss.

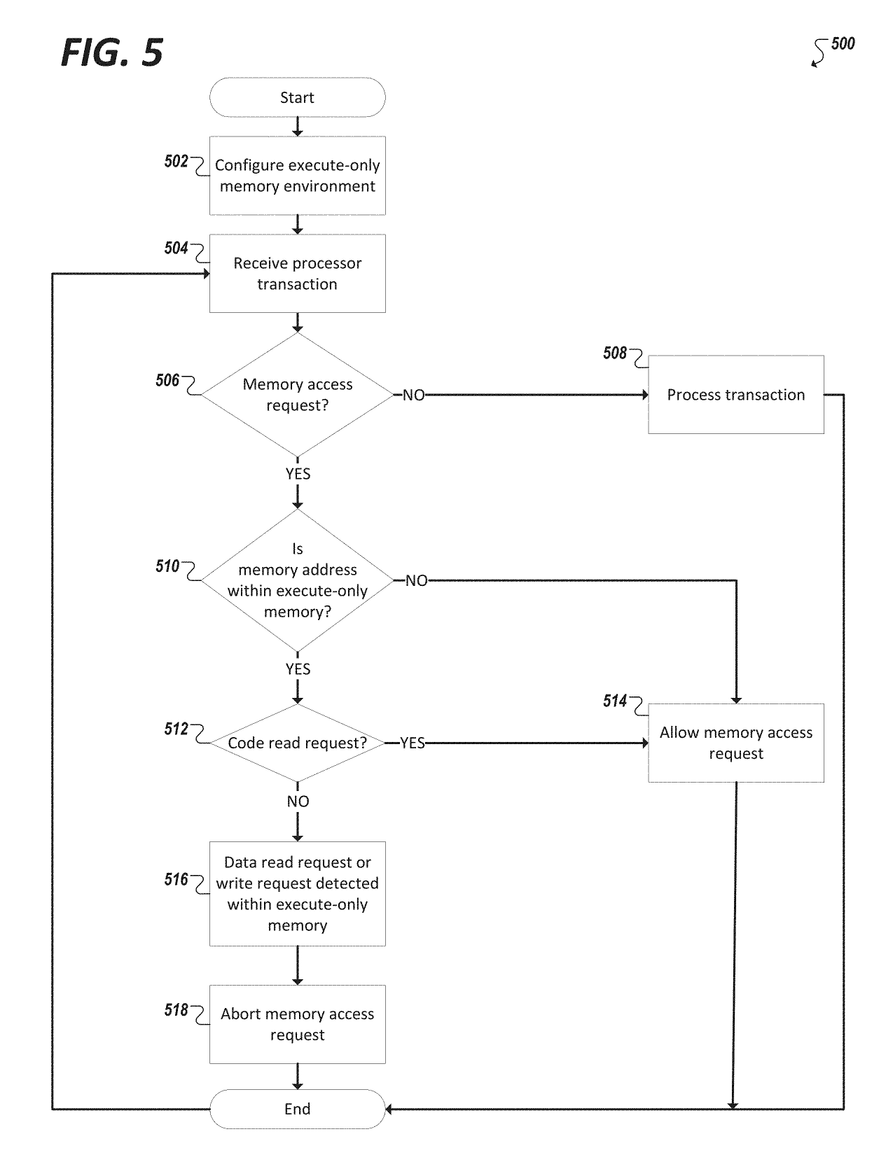

FIG. 5 illustrates an example embodiment of a method 500 for providing execute-only memory using non-unified code and data decoding. Method 500 may be implemented, for example, by computing device 100 from FIG. 1. In particular embodiments, execute-only memory may be a region of memory in a computing device that is used to protect confidential and/or proprietary intellectual property used by the computing device, such as firmware, from being accessed and/or reverse engineered by a user.

The method may start at block 502, where the execute-only memory environment is configured. For example, one or more regions of memory of a computing device may be designated as execute-only memory. The method may then proceed to block 504, where a processor transaction is received. The processor transaction could be, for example, a processor instruction, computation, memory access request (e.g., memory read or write request), etc. The method may then proceed to block 506, where it is determined if the processor transaction involves a memory access request. If it is determined at block 506 that a memory access request is not required, then at block 508 the processor transaction may be processed normally. For example, if the processor transaction is a computation, then the computation may be performed. At this point, the method may be complete for the current processor transaction.

If it is determined at block 506 that a memory access request is required, then at block 510 it is determined whether the memory address identified by the memory access request is within execute-only memory. For example, in some embodiments, a memory range register may be used to identify the regions of memory that are designated as execute-only memory. In those embodiments, it is determined whether the memory address identified by the memory access request is within the regions of memory identified in the memory range register. If it is determined at block 510 that the memory address requested by the memory access request is within execute-only memory, then at block 512 it is determined whether the memory access request is a code read request. For example, in some embodiments, a processor may use different types of memory read requests for reading code versus data. In those embodiments, the processor may use code read requests to read code from memory for execution, and data read requests to read the contents of data stored in memory. If it is determined at block 512 that the memory access request is not a code read request, then at block 516 it is determined that the memory access request is a data read request, or a write request, within execute-only memory. The method then proceeds to block 518, where the memory access request is aborted. In some embodiments, a fixed pattern of data may be returned to indicate that the memory access request has been aborted. At this point, the method may be complete for the current processor transaction.

If it is determined at block 510 that the memory address identified by the memory access request is not within execute-only memory, or if it is determined at block 512 that the memory access request is a code read request, then at block 514 the memory access request is allowed. For example, if the memory access request is a code read request, then the contents of the identified memory address are retrieved from memory. If the memory access request is a write request, then information is written to the identified memory address. At this point, the method may be complete for the current processor transaction.

In particular embodiments, the method may restart at block 504 in order to receive and process a new processor transaction.

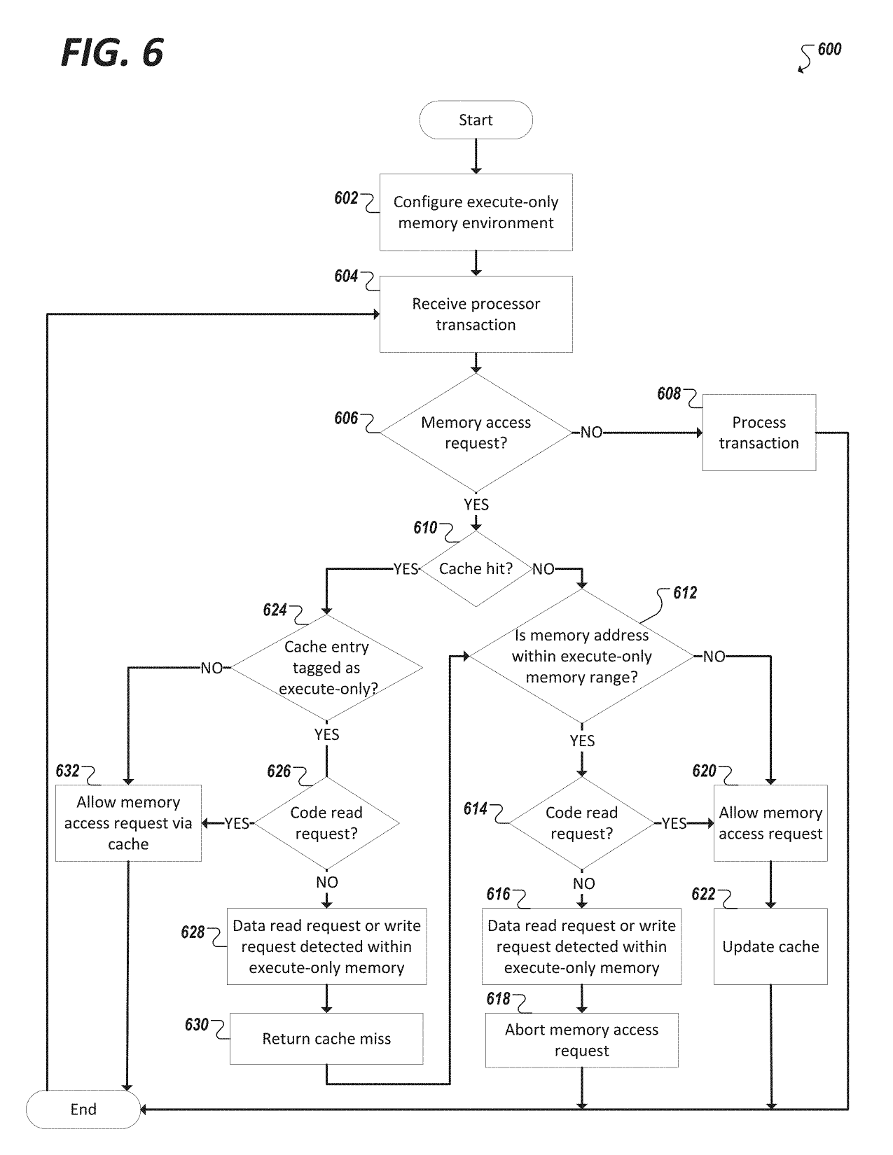

FIG. 6 illustrates an example embodiment of a method 600 for providing execute-only memory using non-unified code and data decoding with a cache. Method 600 may be implemented, for example, by computing device 100 from FIG. 1. In particular embodiments, execute-only memory may be a region of memory in a computing device that is used to protect confidential and/or proprietary intellectual property used by the computing device, such as firmware, from being accessed and/or reverse engineered by a user.

The method may start at block 602, where the execute-only memory environment is configured. For example, one or more regions of memory of a computing device may be designated as execute-only memory. The method may then proceed to block 604, where a processor transaction is received. The processor transaction could be, for example, a processor instruction, computation, memory access request (e.g., memory read or write request), etc. The method may then proceed to block 606, where it is determined if the processor transaction involves a memory access request. If it is determined at block 606 that a memory access request is not required, then at block 608 the processor transaction may be processed normally. For example, if the processor transaction is a computation, then the computation may be performed. At this point, the method may be complete for the current processor transaction.

If it is determined at block 606 that a memory access request is required, then at block 610 it is determined whether there is a cache hit for the memory access request. For example, if the cache contains the contents of the memory address identified by the memory access request, then there is a cache hit. If it is determined at block 610 that there is not a cache hit, then the memory access request must be processed using memory rather than the cache. The method then proceeds to block 612, where it is determined if the memory address identified by the memory access request is within execute-only memory. For example, in some embodiments, a memory range register may be used to identify the regions of memory that are designated as execute-only memory. In those embodiments, it is determined whether the memory address identified by the memory access request is within the regions of memory identified in the memory range register. If it is determined at block 612 that the memory address identified by the memory access request is within execute-only memory, then at block 614 it is determined whether the memory access request is a code read request. For example, in some embodiments, a processor may use different types of memory read requests for reading code versus data. In those embodiments, the processor may use code read requests to read code from memory for execution, and data read requests to read the contents of data stored in memory. If it is determined at block 614 that the memory access request is not a code read request, then at block 616 it is determined that the memory access request is a data read request, or a write request, within execute-only memory. The method then proceeds to block 618, where the memory access request is aborted. In some embodiments, a fixed pattern of data may be returned to indicate that the memory access request has been aborted. At this point, the method may be complete for the current processor transaction.

If it is determined at block 612 that the memory address identified by the memory access request is not within execute-only memory, or if it is determined at block 614 that the memory access request is a code read request, then at block 620 the memory access request is allowed. For example, if the memory access request is a code read request, the contents of the identified memory address are retrieved from memory. The contents retrieved from memory may then be provided to the processor, for example, in response to the memory access request. If the memory access request is a write request, then information is written to the identified memory address.

The method then proceeds to block 622, where the cache is updated with a cache entry containing the contents of the identified memory address. If it was determined at block 612 that the memory address identified by the memory access request is within execute-only memory, then in block 622 updating the cache may also include tagging the cache entry as execute-only (XO). At this point, the method may be complete for the current processor transaction.

If it is determined at block 610 that there is a cache hit, then the memory access request may be processed using the cache rather than memory. The method may then proceed to block 624, where it is determined whether the corresponding cache entry is tagged as execute-only. If it is determined at block 624 that the corresponding cache entry is tagged as execute-only, then at block 626 it is determined whether the memory access request is a code read request. If it is determined at block 626 that the memory access request is not a code read request, then at block 628 it is determined that the memory access request is a data read request, or a write request, within execute-only memory. The method then proceeds to block 630, where a cache miss is returned. For example, although the cache contains the contents of the memory address identified by the memory access request, a data read request or a write request for a cache entry tagged as execute-only (XO) is prohibited, and thus may be treated as a cache miss. The method may then proceed to block 612, where the memory access request may be processed using memory rather than the cache, as described above with respect to blocks 612-622.

If it is determined at block 624 that the corresponding cache entry is not tagged as execute-only, or if it is determined at block 626 that the memory access request is a code read request, then at block 632 the memory access request is allowed and is satisfied using the cache. For example, if the memory access request is a code read request, the contents of the identified memory address are retrieved from the cache. The contents retrieved from the cache may then be provided to the processor, for example, in response to the memory access request. If the memory access request is a write request, then information is written to the cache. At this point, the method may be complete for the current processor transaction.

In particular embodiments, the method may restart at block 604 in order to receive and process a new processor transaction.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, computing devices 100 may be provided, in whole or in part, in an SoC. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

Note also that in certain embodiment, some of the components may be omitted or consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute any type of instructions and/or logic to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), read only memory (ROM), one-time programmable (OTP) memory, an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage component, such as storage 150 of FIG. 1, may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, such as memory 120 and storage 150 of FIG. 1, should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

The following examples pertain to embodiments disclosed in accordance with this specification.

One or more embodiments may provide a machine accessible storage medium having instructions stored thereon that, when executed on a machine, cause the machine to designate one or more regions of memory as execute-only memory, wherein execute-only memory can only be accessed to retrieve code for execution, and wherein a designation of execute-only memory cannot be modified by system software executing on a processor. The instructions may further cause the machine to detect a data read request within the execute-only memory and abort the data read request. In addition, the instructions may further cause the machine to detect a code read request within the execute-only memory and allow the code read request.

In one example, the instructions further cause the machine to: detect a write request within the execute-only memory; and abort the write request.

In one example, the execute-only memory contains firmware.

In one example, one or more keys are embedded in the firmware.

In one example, the one or more keys embedded in the firmware are constant values in one or more processor instructions.

In one example, the one or more keys embedded in the firmware comprise one or more device attestation keys.

In one example, the instructions further cause the machine to load the firmware into the execute-only memory using an authenticated code module.

In one example, the instructions further cause the machine to load the firmware into the execute-only memory using microcode.

In one example, the instructions that cause the machine to abort the data read request further cause the machine to return a fixed pattern of data to indicate that the data read request has been aborted.

In one example, the instructions that cause the machine to designate one or more regions of memory as execute-only memory further cause the machine to store, in a memory range register, one or more memory address ranges corresponding to the execute-only memory. In addition, the instructions that cause the machine to detect the data read request within the execute-only memory further cause the machine to determine if a memory address identified by the data read request is within the one or more memory address ranges stored in the memory range register.

In one example, the instructions further cause the machine to store, in a cache, code that is retrieved from the execute-only memory in response to the code read request, and to store, in the cache, an indication that the retrieved code is from the execute-only memory.

In one example, the instructions further cause the machine to determine if a cache contains a memory address identified by the data read request, determine if the cache contains an indication that the memory address is within the execute-only memory, and return a cache miss if the cache contains the memory address and the indication that the memory address is within the execute-only memory.

One or more embodiments may provide an apparatus comprising a processor, a memory, and a security agent. The security agent may be configured to designate one or more regions of the memory as execute-only memory, wherein execute-only memory can only be accessed to retrieve code for execution, and wherein a designation of execute-only memory cannot be modified by system software executing on a processor. The security agent may further be configured to detect a data read request within the execute-only memory and abort the data read request. The security agent may further be configured to detect a code read request within the execute-only memory and allow the code read request.

In one example, the execute-only memory contains firmware.

In one example, one or more keys are embedded in the firmware as constant values in one or more processor instructions.

In one example, the one or more keys embedded in the firmware comprise one or more device attestation keys.

In one example, the apparatus further comprises an authenticated code module configured to load the firmware into the execute-only memory.

In one example, the apparatus further comprises microcode configured to load the firmware into the execute-only memory.

In one example, the apparatus further comprises a cache configured to store code that is retrieved from the execute-only memory in response to the code read request, and to store an indication that the retrieved code is from the execute-only memory.

In one example, the processor is configured to determine if a cache contains a memory address identified by the data read request, determine if the cache contains an indication that the memory address is within the execute-only memory, and return a cache miss if the cache contains the memory address and the indication that the memory address is within the execute-only memory.

One or more embodiments may provide a method that comprises designating one or more regions of memory as execute-only memory, wherein execute-only memory can only be accessed to retrieve code for execution, and wherein a designation of execute-only memory cannot be modified by system software executing on a processor. The method may further comprise detecting a data read request within the execute-only memory and aborting the data read request. The method may further comprise detecting a code read request within the execute-only memory and allowing the code read request.

In one example, the method further comprises loading firmware into the execute-only memory using an authenticated code module.

1. At least one machine accessible storage medium having instructions stored thereon, the instructions when executed on a machine, cause the machine to:
designate one or more regions of memory as execute-only memory, wherein execute-only memory can only be accessed to retrieve code for execution, and wherein a designation of execute-only memory cannot be modified by system software executing on a processor;
detect a data read request within the execute-only memory;
abort the data read request;
detect a code read request within the execute-only memory; and
allow the code read request.

2. The storage medium of claim 1, wherein the instructions further cause the machine to:
detect a write request within the execute-only memory; and
abort the write request.

3. The storage medium of claim 1, wherein the execute-only memory contains firmware.

4. The storage medium of claim 3, wherein one or more keys are embedded in the firmware.

5. The storage medium of claim 4, wherein the one or more keys embedded in the firmware are constant values in one or more processor instructions.

6. The storage medium of claim 4, wherein the one or more keys embedded in the firmware comprise one or more device attestation keys.

7. The storage medium of claim 3, wherein the instructions further cause the machine to load the firmware into the execute-only memory using an authenticated code module.

8. The storage medium of claim 3, wherein the instructions further cause the machine to load the firmware into the execute-only memory using microcode.

9. The storage medium of claim 1, wherein the instructions that cause the machine to abort the data read request further cause the machine to return a fixed pattern of data to indicate that the data read request has been aborted.

10. The storage medium of claim 1, wherein:
the instructions that cause the machine to designate one or more regions of memory as execute-only memory further cause the machine to store, in a memory range register, one or more memory address ranges corresponding to the execute-only memory; and
the instructions that cause the machine to detect the data read request within the execute-only memory further cause the machine to determine if a memory address identified by the data read request is within the one or more memory address ranges stored in the memory range register.

11. The storage medium of claim 1, wherein the instructions further cause the machine to:
store, in a cache, code that is retrieved from the execute-only memory in response to the code read request; and
store, in the cache, an indication that the retrieved code is from the execute-only memory.

12. The storage medium of claim 1, wherein the instructions further cause the machine to:
determine if a cache contains a memory address identified by the data read request;
determine if the cache contains an indication that the memory address is within the execute-only memory; and
return a cache miss if the cache contains the memory address and the indication that the memory address is within the execute-only memory.

13. An apparatus, comprising:
a processor;
a memory;
a security agent configured to:
designate one or more regions of the memory as execute-only memory, wherein execute-only memory can only be accessed to retrieve code for execution, and wherein a designation of execute-only memory cannot be modified by system software executing on a processor;
detect a data read request within the execute-only memory;
abort the data read request;
detect a code read request within the execute-only memory; and
allow the code read request.

14. The apparatus of claim 13, wherein the execute-only memory contains firmware.

15. The apparatus of claim 14, wherein one or more keys are embedded in the firmware as constant values in one or more processor instructions.

16. The apparatus of claim 14, further comprising an authenticated code module configured to load the firmware into the execute-only memory.

17. The apparatus of claim 13, further comprising a cache configured to:
store code that is retrieved from the execute-only memory in response to the code read request; and
store an indication that the retrieved code is from the execute-only memory.

18. The apparatus of claim 13, wherein the processor is configured to:
determine if a cache contains a memory address identified by the data read request;
determine if the cache contains an indication that the memory address is within the execute-only memory; and
return a cache miss if the cache contains the memory address and the indication that the memory address is within the execute-only memory.

19. A method, comprising:
designating one or more regions of memory as execute-only memory, wherein execute-only memory can only be accessed to retrieve code for execution, and wherein a designation of execute-only memory cannot be modified by system software executing on a processor;
detecting a data read request within the execute-only memory;
aborting the data read request;
detecting a code read request within the execute-only memory; and
allowing the code read request.

20. The method of claim 19, further comprising loading firmware into the execute-only memory using an authenticated code module.
